(19) United States
(12) Patent Application Publication
(10) Pub. No.: US 2015/0286372 A1
(43) Pub. Date: Oct. 8, 2015

(54) METHOD, AN APPARATUS AND A COMPUTER PROGRAM PRODUCT FOR CREATING A USER INTERFACE VIEW

(71) Applicant: JOLLA OY, Helsinki (FI)

(72) Inventors: Thomas Paul Swindell, Cambridge (GB); Jaakko Tapani Samuel Roppola, Mutala (FI); Mikko Antero Harju, Kangasala (FI); Martin Schule, Tampere (FI)

(73) Assignee: Jolla Oy, Helsinki (FI)

(21) Appl. No.: 14/443,379

(22) PCT Filed: Nov. 20, 2012
(86) PCT No.: PCT/FI2012/051141

§ 371 Date: May 16, 2015

(51) Int. Cl. G06F 3/0484; G06F 3/0482

(52) U.S. Cl. CPC G06F 3/04842; G06F 3/0482

(57) ABSTRACT

An apparatus has a display and a user interface view, where the user interface view includes user interface components that are differentiated according to their characteristics into at least content components and effect components. A method includes automatically creating a theme by means of a source image; adjusting the created theme automatically based on sensor data; and rendering the user interface view on the display according to the theme, wherein the theme defines a common appearance of content components and to define the effect of at least one effect component. Technical equipment for performing the method is also described.

### FIELD OF THE INVENTION

This invention relates to a method, an apparatus and a computer program product for providing graphical user interface view on a display of an apparatus.

### BACKGROUND OF THE INVENTION

Portable computers, such as smart phones and tablet devices, are becoming more popular among users and are replacing conventional mobile phones due to their performance. These portable computers have a graphical user interface that includes graphical elements that are shown on the display of the apparatus to a user. The graphical user interface typically consists of a background, selection menus, text, icons and selectable buttons. When talking on graphical user interface, term “theme” is used to define the general appearance (e.g. colouring) of the graphical user interface. Term “theme” is used to describe also the look and feel of the user interface.

Portable computers often have a built-in theme library comprising several computer's brand-related themes having different colouring modes. These themes are selectable by a user in order to change the throughout appearance of the graphical user interface. In addition to these pre-defined themes, pre-created themes can also be downloaded from a network service. There are also services that make it possible for a user to create his/her own theme and to download it to his/her portable computer. Such services list the elements used in the graphical user interface and let the user select colouring for them. When the user is content with the selections, the theme is stored and downloaded to the portable computer.

It is realized that users are increasingly more biased towards customizing the appearance of the user interface of the portable computer according to their own desires. However, todays customization possibilities are based on either vendor-pre-defined themes or theme creator applications that require a network connection and much computing power, but also great amount of graphical elements that need to be varied between user interface views.

Thus, there is a need for a solution that generates user interface view (look and feel and/or theme) dynamically and enables users to customize the graphical user interface easily with less pre-defined resources.

### SUMMARY OF THE INVENTION

This invention is targeted to such a need in order to provide user interface view (look and feel and/or theme) dynamically and enables users to customize the graphical user interface easily with less pre-defined resources. In addition to that, the invention proposes creating user interface view from layers where the theme elements are divided up among the layers. This makes the theme more dynamic compared to the solutions of prior art.

The present invention relates to a method, an apparatus and a computer program product for creating a user interface view to a display.

According to a first aspect, there is provided a method for an apparatus having a display and a user interface view, wherein the user interface view comprises user interface components, where components are differentiated according to their characteristics into at least content components and effect components. The method comprises automatically creating a theme by means of a source image; adjusting the created theme automatically based on sensor data; and rendering the user interface view on the display according to the theme, wherein the theme defines a common appearance of content components and to define the effect of at least one effect component.

According to a second aspect, there is provided an apparatus comprising a processing unit and a memory coupled to said processing unit, said memory configured to store computer program code and a user interface data, wherein the processing unit is configured to execute the program code stored in the memory and to provide a user interface view on a display of the apparatus. The user interface view comprises user interface components that are differentiated according to their characteristics into at least content components and effect components. The apparatus is configured to automatically create a theme by means of a source image; adjust the created theme automatically based on sensor data; and render the user interface view on the display according to the theme, wherein the theme defines a common appearance of content components and to define the effect of at least one effect component.

According to a third aspect, there is provided a computer program product comprising program code to be executed in an apparatus, wherein the computer program product comprises user interface data for providing a user interface view on a display of an apparatus. The user interface view comprises user interface components, which user interface components are differentiated according to their characteristics into at least content components and effect components. The computer program product comprises instructions for automatically creating a theme by means of a source image; adjusting the created theme automatically based on sensor data; and rendering the user interface view on the display according to the theme, wherein the theme defines a common appearance of content components and to define the effect of at least one effect component.

According to an embodiment the user interface components comprise also a background component configured to provide a background for the user interface view. According to an embodiment, the background component is defined according to the created theme. According to an embodiment, the content component comprises graphical elements, wherein the method comprises defining at least the colouring of the graphical elements according to the theme. According to an embodiment, the theme is created one or more of the following steps: collecting a hue histogram of hue of the source image, collecting a pixel histogram of pixel values, selecting the most common hue as dominant colour from the hue histogram, finding median value from the pixel histogram, blur the source image, darken the source image depending on the median value, use the source image as a background image for the theme, use the dominant colour as theme colour, select one or more font colours from the hue histogram, modifying alpha value and/or colour of the effect component. According to an embodiment, the background component is adjusted by means of the sensor data. According to an embodiment, the effect component is a diffusing component, wherein the method comprises adjusting the user interface view with respect to the other user interface components by means of said diffusing component. According to an embodiment, the effect component is configured to create an effect for at least part of the content component. According to an embodiment, the effect component is configured to change illumination levels on the user interface view by means of bump mapping. According to an embodiment, the alpha channels of the effect component are adjusted. According to an embodiment, the alpha channels of the effect component are adjusted according to state of a certain functionality. According to an embodiment, sensor data concerning the ambient environment is received, and the effect component is adjusted by means of said sensor data. According to an embodiment, the sensor data is received from one or more of the following: magnetometer, accelerometer, positioning means, camera or thermometer.

According to a fourth aspect, there is provided a method for an apparatus having a display and a user interface view, wherein the user interface view comprises user interface components. The method comprises automatically creating a them by means of a source image, adjusting the created theme automatically based on sensor data, and rendering the user interface view on the display according to the theme, wherein the theme defines a common appearance of the user interface components.

According to a fifth aspect, there is provided a method for an apparatus having a display and a user interface view, wherein the user interface view comprises user interface components for defining the appearance of the user interface view, wherein the method comprises receiving sensor data concerning the ambient environment, adjusting at least part of the user interface components by means of said sensor data.

According to an embodiment, effect of the user interface components is adjusted by means of the sensor data. According to an embodiment, the effect defines illumination for the user interface view. According to an embodiment, the sensor data relates to an ambient illumination level.

### DESCRIPTION OF THE DRAWINGS

The invention is now described in more detailed with reference to the drawings, where

FIG. 1 illustrates an example of a portable computer;

FIG. 2 illustrates another example of a portable computer;

FIG. 3 illustrates an example a multilayer user interface;

FIG. 4 illustrates an example of an automatic theme creation;

FIG. 5 illustrates a method for creating a user interface view;

FIG. 6 illustrates another example of multilayer user interface view;

FIG. 7a illustrates an example of a layer providing an illumination area;

FIG. 7b illustrates an example of one illumination generating layer;

FIG. 7c illustrates an example of two illumination generating layers;

FIG. 8a illustrates an example of an effect component;

FIG. 8b illustrates an example of an effect component in a user interface view; and

FIG. 9 illustrates an example of a user interface view on a display.

### DETAILED DESCRIPTION OF THE INVENTION

The present invention is described next by using a smart phone as an example of the apparatus. However, the teachings of the present solution may be utilized also in other computing devices having a display and a graphical user interface. Examples of such devices are tablet and laptop computers.

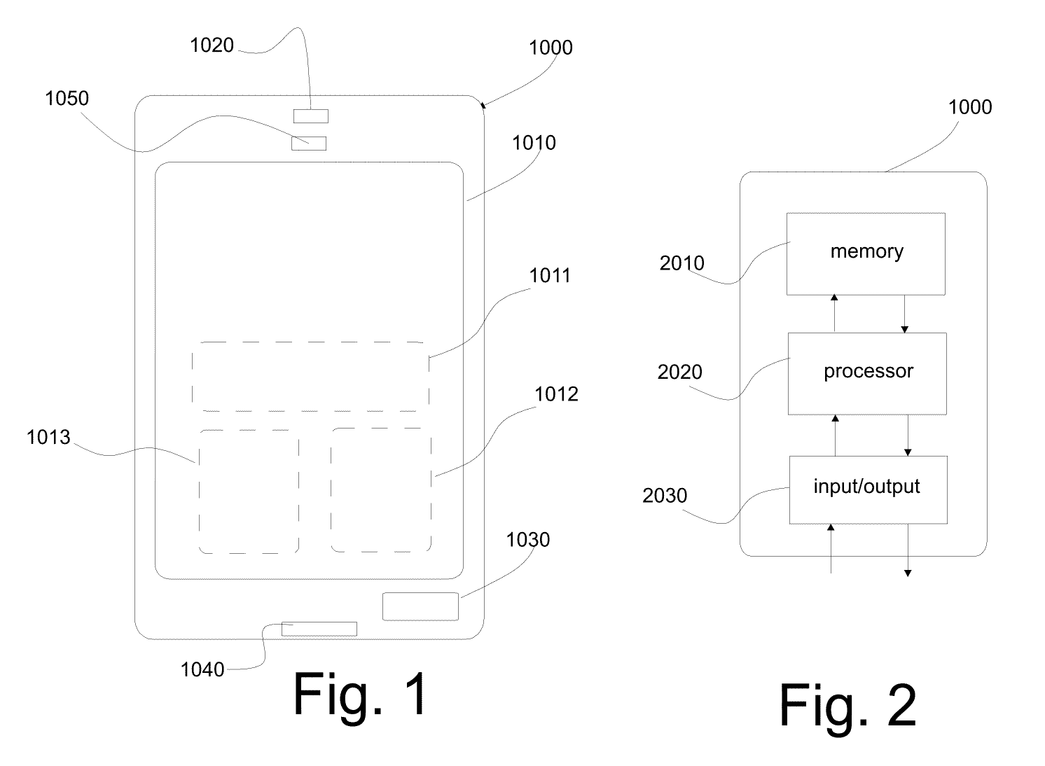

FIG. 1 shows an example of an apparatus (1000). The apparatus (1000) comprises a display (1010), which may be a touch-screen display (e.g. capacitive, resistive). The display can consist of a backlight element and a LCD (Liquid Crystal Display) in the front of the backlight. The backlight can be even (i.e. same illumination level throughout the display) or the distribution of the light can be controlled depending on the backlight type.

The apparatus according to FIG. 1 further comprises at least one camera (1020) being situated on same side of the apparatus with the display, or on the opposite side. According to an embodiment, the apparatus comprises two cameras placed on opposite sides of the apparatus (1000), e.g. front side (i.e. display side) and rear side of the apparatus. According to yet an embodiment, the apparatus have a data transmission connection to an external camera to receive image data. The apparatus (1000) may have one or more physical buttons (1030) and one or more touch-screen buttons (1012-1013). In an embodiment, the apparatus (1000) comprises either physical buttons or touch-screen buttons. The apparatus (1000) comprises a keypad being provided on the display as a touch-screen keypad (1011) and/or on the housing of the apparatus (1000) as a physical keypad. The apparatus (1000) may further comprise a microphone (1040) and loudspeaker (1050) to receive and to transmit audio. The apparatus (1000) may also comprise communication interface (not shown in FIG. 1) configured to connect the apparatus to another device, e.g. a server or a terminal, via wireless and/or wired network, and to receive and/or transmit data by said wireless/wired network. Wireless communication can be based on any cellular or non-cellular technology, for example GSM (Global System for Mobile communication), WCDMA (Wideband Code Division Multiple Access), CDMA (Code Division Multiple Access). Wireless communication can also relate to short range communication such as Wireless Local Area Network (WLAN), Bluetooth etc. The apparatus (1000) also comprises a battery or similar powering means. The apparatus (1000) may comprise one or more sensors, such as accelerometer, gyroscope, magnetometer etc. The apparatus (1000) may also comprise a vibrator for providing movement of the apparatus in silent mode and for providing tactile feedback in user interface situations.

The apparatus (1000) further comprises a memory (FIG. 2: 2010) configured to store computer program code used for operating the apparatus and for providing user interface, and to store user interface data. User interface related software can be implemented as separate application and/or it can be part of the operating system of the apparatus. The application and/or operating system can be upgraded by a server system to alter configuration and functionality of the user interface. Additionally the application and/or operating system can be upgraded via personal computer/laptop to alter configuration and functionality of the user interface. User interface may include default values and it may include values which can be modified by the users. The apparatus (1000) comprises a processor (2020) that executes the program code to perform the apparatus' functionality. The apparatus further comprises an input/output element (2030) to provide e.g. user interface views to a display (FIG. 1: 1010) of the apparatus, or audio via loudspeaker (FIG. 1: 1050), or vibration using vibrating element/functionality of the apparatus (1000) and to receive user input through input elements, such as buttons (FIG. 1: 1011, 1012, 1013, 1030), microphone (FIG. 1: 1040) or camera (FIG. 1: 1020). The input buttons can be used by fingers, stylus, touch pad, mouse, joystick, etc.

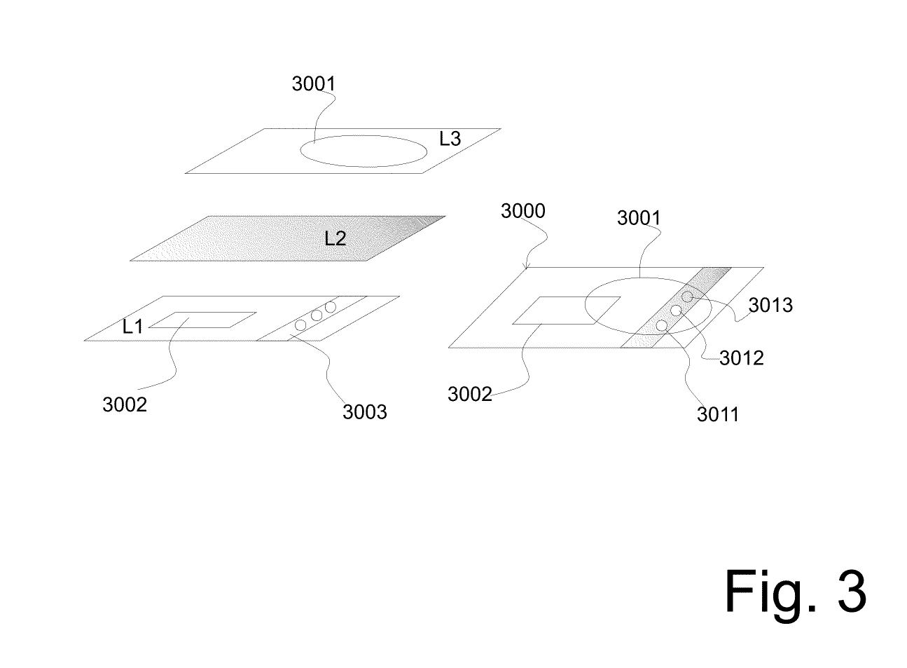

According to an embodiment, the user interface view can be understood to be created from multiple user interface components. There can be different kinds of user interface components which can be classified according to their nature into various groups. In the example of FIG. 3, the user interface components are layerized as virtual layers L1-L3. One of the component groups relates to content components containing the graphical elements, i.e. content elements, of the user interface. The graphical element is a written or pictorial representation of an element, such as text, icon, menu. In FIG. 3, this group is shown as layer L3, which is the most upper layer from the user's point of view.

One of the component groups may relate to background components and comprise the background image and can provide illumination effect for the graphical elements and illumination level for the user interface view. In FIG. 3, this group is shown as layer L1.

There can be yet other type of graphical user interface components to create a user interface view, for example a diffusing component that is configured to blur (diffuse) the view with respect to the other user interface components. In FIG. 3, such a diffusing component is shown as layer L2, which can be situated between layers L3 and L1.

As said, the background component comprises the background image and may define the illumination level for the view. The background component may define bump map parameters to be used for the user interface view. For the purposes of the present invention, the bump mapping is implemented by software. However, in some embodiments, the bump mapping can be created by using back light of the display. For example, if the back light is given by LED (Light Emitting Diode) where the illumination can be controlled within a picture (sub areas of the display or per pixel), the back light can be used as bump map. The background image in the background component can be modified to form illumination type of effects in the user interface. For example, an area 3002 in the background image can be adjusted to have larger illumination values that normally. The modification of the illumination values would result in effect of said area looking more bright than other areas in the user interface. Alternatively for changing illumination levels for making the digital light effect, bump mapping can be used.

Bump mapping is a technique by means of which normal angle (seen from user's point of view) of a brightness or shading of the pixel is changed slightly in order to provide an illumination effect for that pixel. The pixel itself is not obstructed but the shading of it is modified. As a result of bump mapping, the pixel can be seen to moved closer to a user by a distance e.g. creating a bump.

As mentioned earlier, the diffusing component, a, also called a glossy glass component, is used to diffuse (blur) at least one other user interface component (in FIG. 3, the background component). The diffusing component may also comprise e.g. a moving image as the blur image in order to generate e.g. movements to the other component.

The content component can comprise graphical elements, such as text, icons, menus.

In the following, a method for customizing the user interface components automatically is discussed. It is known to have a theme for graphical elements in the user interface. The theme defines the common appearance for the graphical elements, e.g. a common colouring for fonts, for icons, for background etc. The theme can be changed according to moods of the user, whereby the appearance of the user interface is changed accordingly. It is realized that the theme creates look and feel for the user interface.

Each of the above user interface components, independently on the implementation means, can have certain characteristics which can be customized. This customization refers basically setting up/defining/configuring/creating of a theme for the graphical user interface, which modifies the appearance of the graphical user interface so that the various user interface components share one or more certain visual factors being defined by the theme. According to embodiments, in order to perform customization, an inputted or stored image is processed to obtain parameters by means of which colouring scheme, illumination levels, dark levels, bright levels, glossy effects etc. being represented by various user interface components can be modified when the user interface view is rendered.

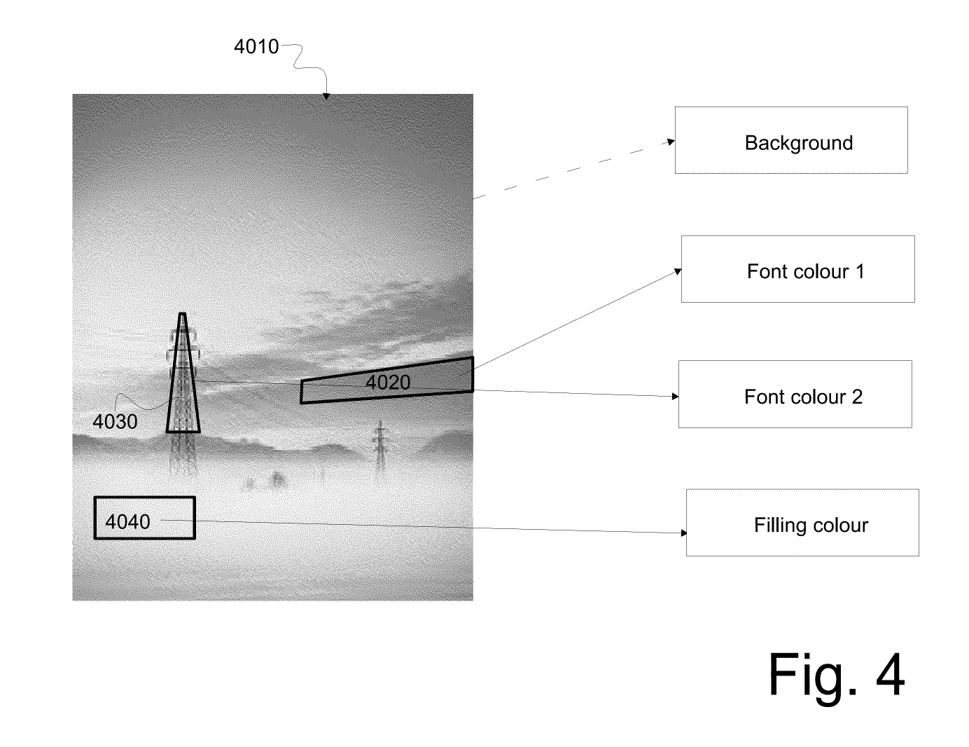

FIG. 4 illustrates an example of an image (4010) that is analysed to have theme for a user interface. It is known to use an arbitrary user-selected image as a background of a user interface, however other graphical elements (text, icons, menus, etc.) are not automatically adjusted according to it. In the present solution, the image can be used as a background for the user interface, but also other graphical elements and effects are automatically customized according to the data obtainable from the image. For the purposes of the present invention, the image can be a still image captured by the apparatus or downloaded from a service. The image can also be a video or some other moving images.

The image (4010) is analysed to determine colour space to be used for graphical elements for example in the content component. The analysis finds certain characteristics of the picture, for example contrast level changes, contours, areas with certain colours (or colour space) in colour map, e.g. certain range of RGB values (Red Green Blue) or other data such as luminance or chrominance, areas with certain brightness (minimum brightness to maximum brightness), objects, symbols etc.

For example, area 4020 is an area which corresponds to a relative size of entire figure with certain grey levels. An object 4030 is recognized from the image by using e.g. pattern recognition methods. Area 4040 is an area with certain brightness level. According to an embodiment, the image analysis is carried out by following steps:
collect a hue histogram of hue values (in HSV (Hue Saturation Values) colour space) of image pixels for pixels whose saturation is non-zero;
collect a pixel histogram of pixel values;
select the most common hue as dominant colour from the hue histogram. If there are only gray/black/white pixels, use a default value;
find median value from the pixel histogram;
blur the source image to have a background image;
darken the background image depending on the median value;
   if the median value is higher than 50%, darken the background image with 0.5 RGB pixel multiplier
   else darken the background image with 0.75 RGB pixel multiplier
reduce visibility of colour banding by adding noise;
select one or more colours from the hue histogram
create a theme of the background image and the dominant colour and the other colours;
apply the generated theme to user interface view.

The method can contain all the previous steps or any combination of the selected steps.

It is realized that the theme contains customization on various user interface components, i.e. not only in the content component, but also in other components (background component, effect component, diffusing component) defining effects for the user interface view.

Turning to FIG. 4, the average colour of area (4040) can be used for background colour for graphical elements in the content component. An example a graphical element is a form, a shape, having a background colour (filling colour) of the average colour of area (4040). The average colour of area (4020) is used as font colour 1. The colour of object (4030) is used as font colour 2. The background colour and font colours 1, 2 can then be used in a theme of the user interface view. Additionally the source image (4010) can be used as background image for the background component.

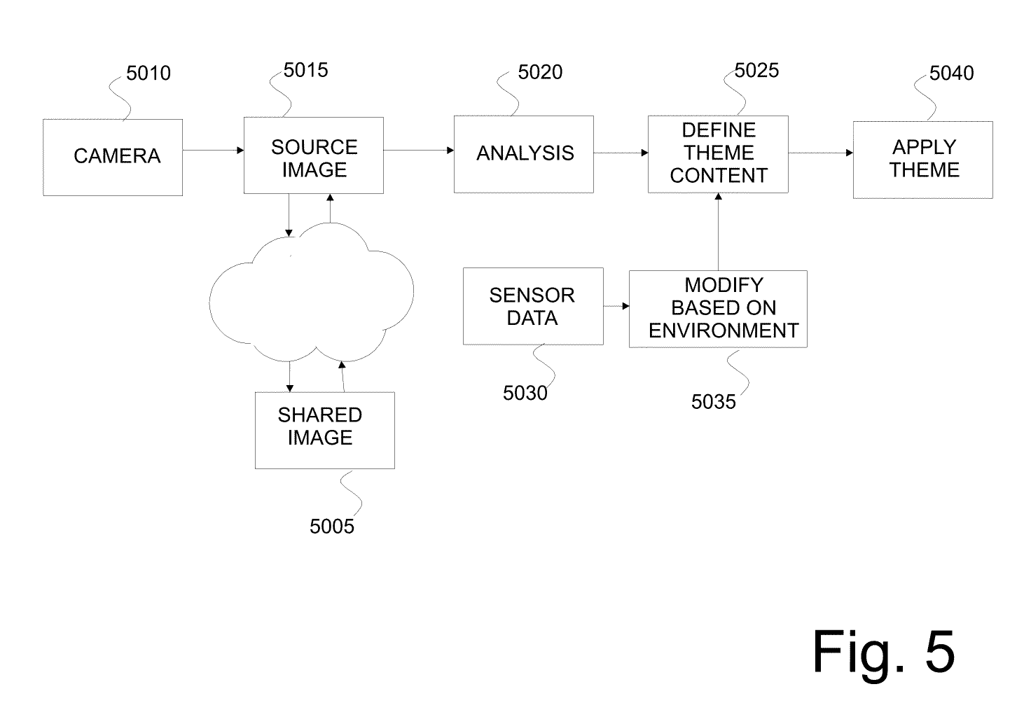

Theme creation method according to an embodiment is shown in FIG. 5. A source image (5015) is captured by a camera (5010) or obtained from the service (5005). The service can be a social networking service such as Facebook, Twitter, etc. or an image gallery such as Flickr, Picasa, etc. from where the image is obtained. The source image is then analysed (5020) e.g. by using the above described method to have a theme content (5025) comprising e.g. the colouring mode.

The theme can be further modified (5035) dynamically according to data (5030) being received from sensors sensing the environment. The sensor data can be received from one or more of the following sensors: magnetometer, accelerometer, location, camera, temperature. For example, a front camera can be used to determine the ambient illumination level and the direction of illumination, which information can be utilized for determining illumination effect parameters for the user interface components. When the theme content is ready, the theme (i.e. colours, illumination effects) is applied (5040) to all or some of the visual software components on the user interface view. It is to be noticed that each time a sensor data is received, the created theme can be adjusted only with respect to some of the user interface components. For example, if it is noticed that a surrounding illumination level has decreased, only the illumination level defined by the background component is modified or the diffusing component is adjusted accordingly. However, there is no need to touch the content component or the overall colouring of the user interface view.

Turning back to FIG. 3, showing a user interface view (3000) being created from user interface components, such as layers L1-L3. The content layer L3 comprises a graphical element (3001) and the background layer L1 comprises a bitmap (3002) as background image. Bump mapping can be used to create illumination effect for the bitmap (3002). Also the background layer L1 comprises dots within area (3003), which can be illuminated to indicate whether a certain functionality shown on the content layer L3 is selected or not. The diffuse layer L2 can be used to diffuse the light/image content coming from the background layer L1. It is realized that layers L3 and L1 have content which can be used together to indicate functionality to the user. Layer L3 defines which functionality and layer L1 defines the state of the functionality with the illumination (state “on”, “active”, “running”, “in use” with light (3011, 3012); state “off”, “inactive”, “stopped”, “not in use” without light (3013)). This deviates greatly from what is known in this technical field. Typically such indication is made with graphics and bitmaps, e.g. by varying the colouring of an icon from green to red or by attaching a text next to the icon describing the state of the functionality. However, with the user interface structure according to the present embodiments, the amount of graphical elements on layer L3 can be reduced, because indications can be implemented with illumination.

According to an embodiment the illumination levels of layer L1 can be altered according to a sensor data of apparatus (1000) such as camera 1020, as mentioned above. For example if the camera 1020 (or other illumination measurement mean) indicates that the apparatus is being used in dark illumination conditions the illumination level of the layer L1 can be decreased. Similarly if the apparatus is used in bright illumination environment illumination level of layer L1 can be increased to modify theme dynamically. Additionally sensor data such as accelerometer can be used to detect orientation of the apparatus and the themes can be varied based on the orientation. For example direction of bump mapping vectors can be changes to take in account the orientation of the apparatus (gravity effect).

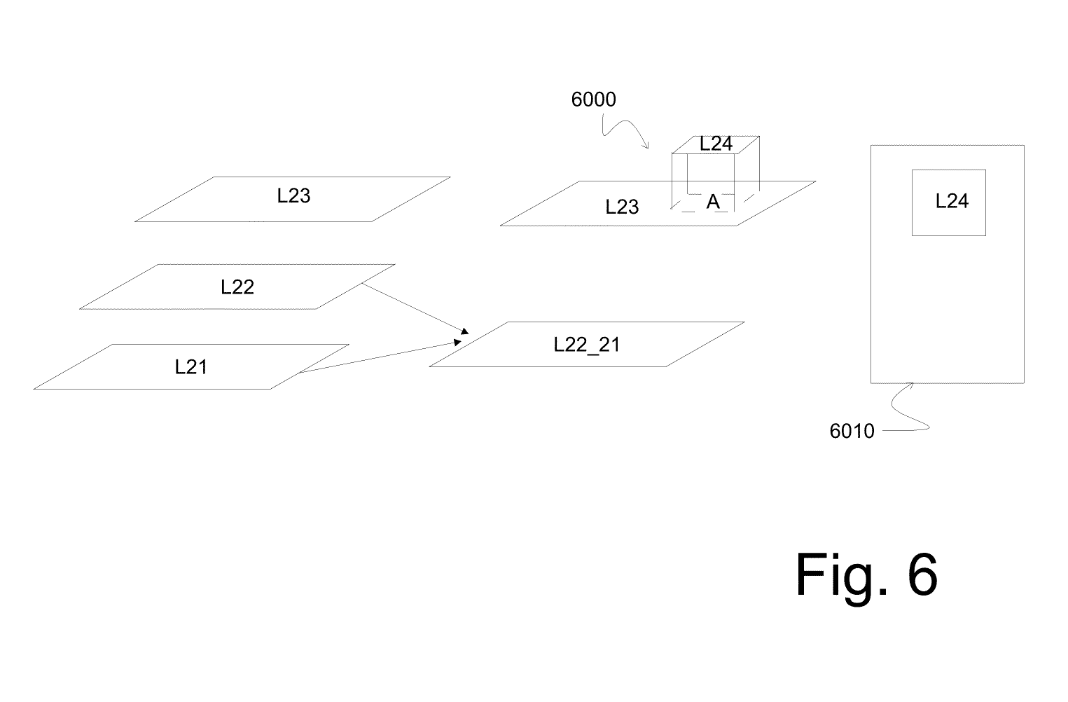

FIG. 6 shows yet another example of a user interface view. Also in this example, the user interface components are displayed in such a manner that the user interface view appears for the user as being constructed from multiple layers. The user interface view is created by user interface components L21, L22, L23 that can be layerized or overlap each other. Component L21 is the background image (e.g. a photo), component L22 is the diffusing component and component L23 is the content component. The diffuse component L22 can be a component having alpha channel value 0.1, for example, i.e. transparent. The content component L23 may comprise graphical elements, such as text, icons, menu, which typically change as the user uses the apparatus. Components L21 and L22 can be merged together as L22_21 component if the component s L21 and L22 are static for a time being. In practice said merging of two graphical elements L21 and L22 can be done in multiple ways for example using OpenGL graphics libraries.

Alpha channel values define a transparency of an object, a user interface component, e.g. a layer, a graphical element, bitmap, where alpha channel value 0 relates to total transparency and alpha value 1 relates to non-transparency. When diffuse layer L22 has an alpha channel value 0.1, the content of layers below (i.e. L21) can be seen through the diffuse layer. If the diffuse layer L22 has an alpha channel value close to 1, the content of layers below (i.e. L21) cannot be seen.

In order to create an illumination effect on area A of the content component L23, an effect component L24 can be located on top of the content component L23 (as shown with reference 6000). The effect component L24 can be dimensioned to be smaller than the entire picture to save computational power. It is appreciated that the effect component L24 can also cover the entire picture. Reference 6010 shows a user interface view with effect component L24.

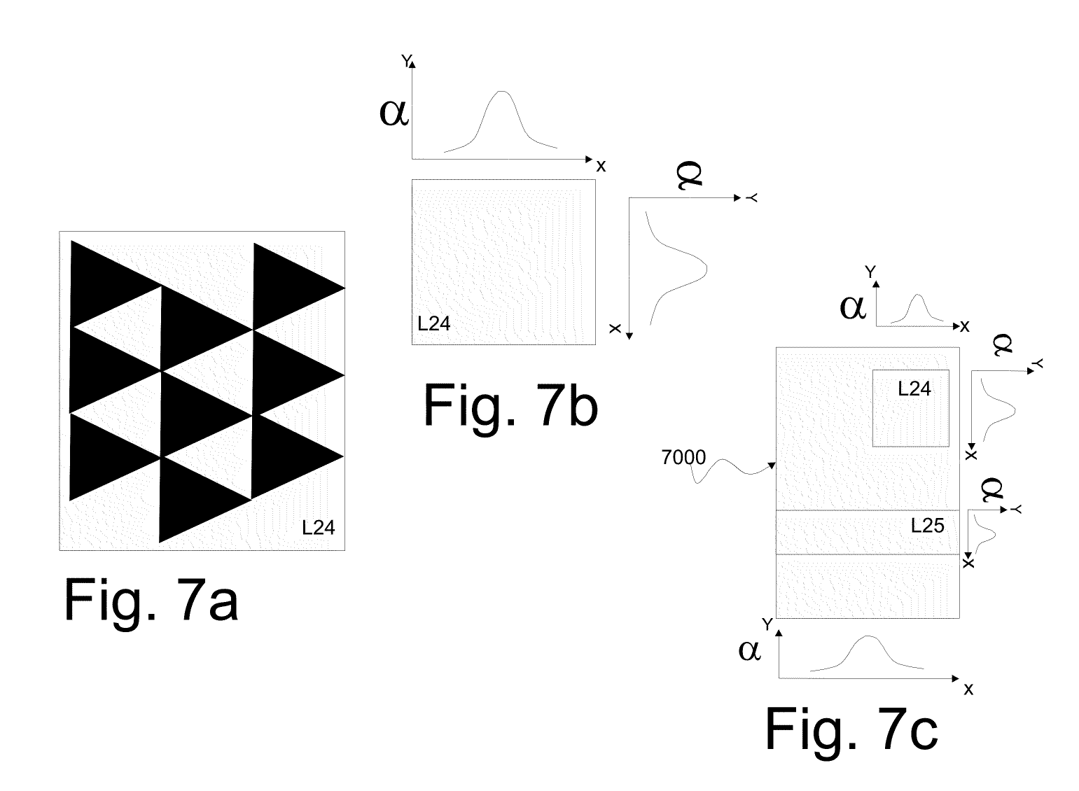

FIG. 7a shows details of effect component L24 according to an embodiment. The effect component L24 can be a bitmap. The bitmap may contain visual data, e.g. triangle shapes as in FIG. 7a, but also other shapes such as circles, squares or arbitrary bitmaps including solid bitmap.

Black colour of triangles indicates the colour of the effect component L24 (which can be of any colour, e.g. white, red, green, blue, . . . ). White colour triangles (and other white area) in the FIG. 7a indicates fully transparent area. Preferably, the ratio of fully transparent areas of the effect component L24 to the coloured areas is about 50:50. The colour can be automatically selected according to the theme having been created from a source image, wherein the colour can be the most bright colour in the source image. Alternatively, the colour can be a default colour defined in the user interface software.

In order to implement a smooth light box, an alpha channel (α) is applied to pixels of the effect component L24 as shown in FIG. 7b. This results in a bitmap with bright spot (of selected colour) in the middle, since alpha value in the middle (X-axis- and Y-axis-wise) is large. The effect component L24 is completely transparent from the sides since the alpha value (α) is low or close to zero in the sides. Preferably, the alpha channel is applied only to colour triangles of the component L24 (i.e. black colour triangles) and alpha channel of white is kept 0 i.e. transparent.

Basically alpha values create contour plots with alpha value (α) close to 1 in the middle with decreasing alpha value as the radius from the middle of the effect component L24 increases. The alpha value (α) at the edge is zero or very close to zero.

FIG. 7c illustrates an example of a user interface view 7000 having two effect components L24, L25. In this example the effect components L24, L25 are also light generating layers on top of the content component. Similarly, as in FIG. 7b, the light boxes for effect components L24, L25 are created by applying alpha channels (α) to pixels of the effect components L24, L25. As a result of this, bitmaps with bright spot (of selected colour) in the middle are generated, since alpha value in the middle (X-axis- and Y-axis-wise) is large. The effect components L24, L25 are completely transparent from the sides since the alpha value (α) is low or close to zero in the sides.

According to the embodiments some or all visual characteristics of said components (L21, L22, L_22_21, L23 and L24) are defined by theme. The theme related parameters can be created automatically from a source figure as discussed earlier. For example, the form factor of alpha channel function (see for example FIG. 7b) can be correlated with form factor from certain details of the source image. For example, if dominant forms in the source image are circles, then the applied alpha channel contour in top of bitmap on component L24 can be for example circular. If, based on created theme, dominant colour in the source figure is red, the colour of the component L24 bit map can be set to red. This would result in “red light” type of illumination created by the effect component L24. Benefit of using said technique of modifying effect component L24 with the theme instead of graphical elements such as icons is saving of computational power.

As discussed, sensor data of apparatus (1000) such as camera (1020) can be used as input to alter theme parameters related to alpha values. Sensor data can be used to take in consideration illumination conditions of the environment. For example if the camera (1020) (or other illumination measurement mean) indicates that the apparatus is being used in dark illumination conditions alpha values of applied alpha channel can be decreased. Similarly if the apparatus is used in bright illumination environment the alpha channel values can be increased (i.e. made closer to 1).

Further, according to embodiments, the effect component L24 graphics (bitmap) can be modified using bump mapping. The orientation and characteristics of said bump mapping are parameters in a theme. The bump map parameters related to the bitmap in effect component L24 can be altered for example to take in account orientation of the device i.e., the theme can be dynamically altered.

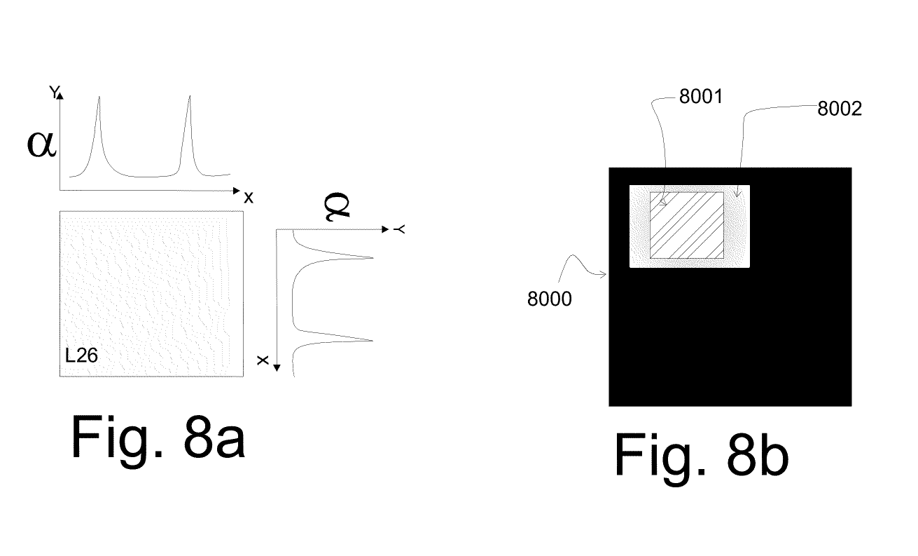

FIG. 8a illustrates yet another example of an effect component L26, the purpose of which is to highlight a graphical element on the content component by glowing. This can be implemented by applying alpha channels (α) to pixels of the effect components L26 as shown in FIG. 8a. As a result of this, a bitmap with transparent area in the middle are generated, since alpha value in the middle (X-axis- and Y-axis-wise) is zero. The effect component L26 has bright sides since the alpha value (α) is large in the sides. When this kind of an effect component (FIG. 8b: 8002) is used when rendering the user interface view (FIG. 8b:8000), a graphical element (8001) “underneath” the effect component (8002) seems to glow.

This kind of an implementation is useful in a situation, where graphical element 8001 is an icon of a certain functionality. When the functionality is running, the alpha channels are applied to the effect component as shown in FIG. 8a. When the functionality is inactivated, the alpha channels may be reset to zero.

The user interface components can be implemented in various ways. For example, when using OpenGL software libraries the “layer like” representation of the user interface is created by painting the elements in the graphical memory in certain order. The order can be generated by painting the elements from “bottom to top” or it can be such that only visible elements are constructed in the display memory and further rendered.

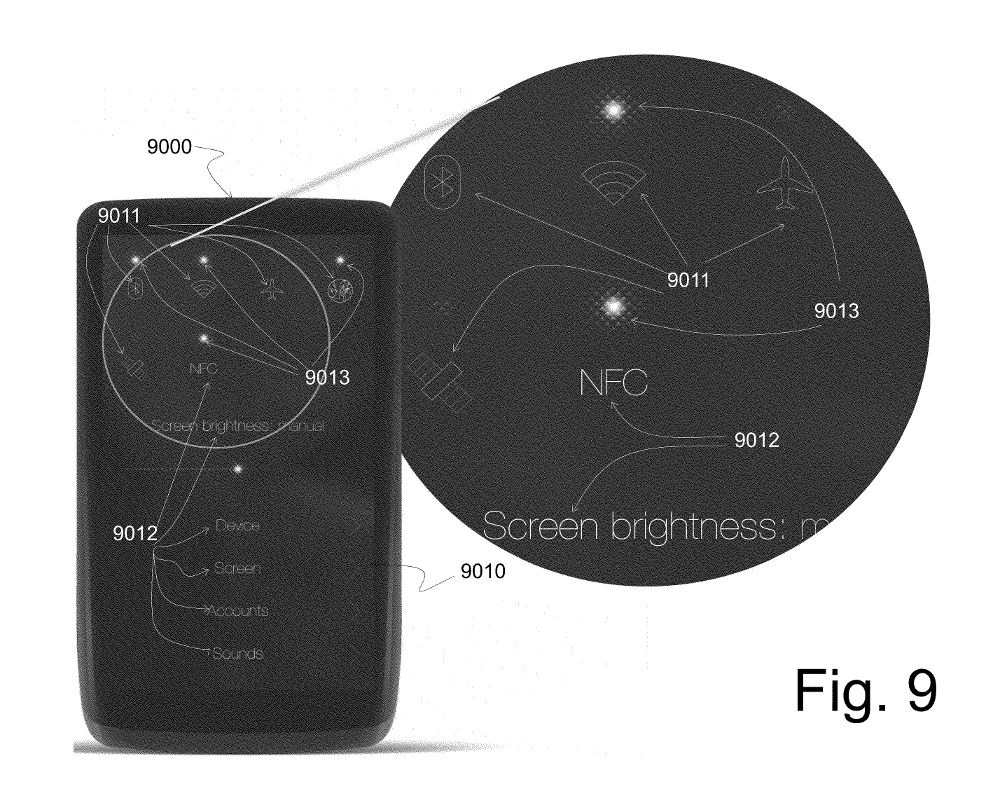

FIG. 9 illustrates an example of a computer (9000) having a display (9010). The display (9010) displays a user interface view, where the text (9012) and icons (9011) are located on the content component, and where the illumination effect (9013) is provided by additional effect components, as shown in FIGS. 7a-7c i.e. by setting an effect component L24 (see FIG. 6.) in appropriate position or by bump mapping as shown in FIG. 3. The illumination effect is generated to small areas (9013) to indicate whether the functionality defined by graphical elements (9011) is active or not. According to embodiments, the colour of the illumination effect is defined in a theme and can be altered dynamically for example based on sensor data or user input.

The present invention concerns a graphical user interface that is dynamic in a sense that it can be customized according to user's desires easily and with less pre-defined resources. Different components of the graphical user interface provide different effects for the user interface view and also provides state indication for functionality without modifying the graphical element representing the functionality. The invention represents a substantial advancement compared to the user interface view customization methods of related art, because the present solution does not need any other input from the user but a source image to create automatically image-related appearance throughout the user interface views.

The present invention is not limited solely to the above-presented embodiments, but it can be modified within the teachings of the appended claims.

1. A method for creating a user interface view for an apparatus having a display, wherein the user interface view comprises user interface components, wherein user interface components are differentiated according to their characteristics into at least content components and effect components, wherein the method comprises automatically creating a theme by means of a source image;
adjusting the created theme automatically based on sensor data; and
rendering the user interface view on the display according to the theme, wherein the theme defines a common appearance of content components and to define the effect of at least one effect component.

2. The method according to claim 1, wherein the user interface components comprise also a background component configured to provide a background for the user interface view.

3. The method according to claim 2, wherein the method comprises at least one of the following:
defining the background component according to the created theme;
when the content component comprises graphical elements, defining at least the colouring of the graphical elements according to the theme;
adjusting also the background component by means of the sensor data;
when the effect component is a diffusing component, adjusting the user interface view with respect to the other user interface components by means of said diffusing component;
adjusting alpha channels of the effect component;
adjusting the alpha channels of the effect component according to state of a certain functionality;
receiving sensor data concerning the ambient environment, and adjusting the effect component by means of said sensor data;
receiving the sensor data from one or more of the following: magnetometer, accelerometer, positioning means, camera or thermometer.

4. (canceled)

5. The method according to claim 1, wherein for creating the theme the method comprises one or more of the following steps:
collecting a hue histogram of hue of the source image,
collecting a pixel histogram of pixel values.
selecting the most common hue as dominant colour from the hue histogram,
finding median value from the pixel histogram,
blur the source image,
darken the source image depending on the median value,
use the source image as a background image for the theme,
use the dominant colour as theme colour,
select one or more font colours from the hue histogram,
modifying alpha value and/or colour of the effect component.

6.-7. (canceled)

8. The method according to claim 1, wherein the effect component is configured to
create an effect for at least part of the content component and/or
change illumination levels on the user interface view by means of bump mapping.

9.-13. (canceled)

14. An apparatus comprising a processing unit and a memory coupled to said processing unit, said memory configured to store computer program code and a user interface data, wherein the processing unit is configured to execute the program code stored in the memory and to provide a user interface view on a display of the apparatus, wherein the user interface view comprises user interface components that are differentiated according to their characteristics into at least content components and effect components, wherein the apparatus is configured to
automatically create a theme by means of a source image;
adjust the created theme automatically based on sensor data; and
render the user interface view on the display according to the theme, wherein the theme defines a common appearance of content components and to define the effect of at least one effect component.

15. The apparatus according to claim 14, wherein the user interface components comprise also a background component configured to provide a background for the user interface view.

16. The apparatus according to claim 15, wherein the apparatus is configured to
define the background component according to the created theme;
adjust also the background component by means of the sensor data;
when the effect component is a diffusing component, adjust the user interface view with respect to the other user interface components by means of said diffusing component;
create an effect for at least part of the content component;
change illumination levels on the user interface view by means of bump mapping;
adjust alpha channels of the effect component;
adjust the alpha channels of the effect component according to state of a certain functionality;
receive sensor data concerning the ambient environment, and to adjust the effect component by means of said sensor data.

17. (canceled)

18. The apparatus according to claim 14, wherein for creating the theme the apparatus is configured to perform one or more of the following steps:
collecting a hue histogram of hue of the source image,
collecting a pixel histogram of pixel values.
selecting the most common hue as dominant colour from the hue histogram,
finding median value from the pixel histogram,
blur the source image,
darken the source image depending on the median value,
use the source image as a background image for the theme,
use the dominant colour as theme colour,
select one or more font colours from the hue histogram,
modifying alpha value and/or colour of the effect component.

19.-25. (canceled)

26. The apparatus according to claim 14, wherein the apparatus comprises one or more of the following: magnetometer, accelerometer, positioning means, camera or thermometer for providing the sensor data.

27. A computer program product comprising program code to be executed in an apparatus, wherein the computer program product comprises user interface data for providing a user interface view on a display of an apparatus, wherein the user interface view comprises user interface components, which user interface components are differentiated according to their characteristics into at least content components and effect components and wherein the computer program product comprises instructions for
automatically creating a theme by means of a source image;
adjusting the created theme automatically based on sensor data; and
rendering the user interface view on the display according to the theme, wherein the theme defines a common appearance of content components and to define the effect of at least one effect component.

28. The computer program product according to claim 27, wherein the user interface components comprise also a background component configured to provide a background for the user interface view.

29. The computer program product according to claim 28, wherein computer program product comprises at least one of the following:
instructions for defining the background component according to the created theme;
when the content component comprises graphical elements, instructions for defining at least the colouring of the graphical elements according to the theme;
instructions for adjusting also the background component by means of the sensor data;
when the effect component is a diffusing component, instructions for adjusting the user interface view with respect to the other user interface components by means of said diffusing component;
instructions for adjusting alpha channels of the effect component;
instructions for adjusting the alpha channels of the effect component according to state of a certain functionality;
instructions for receiving sensor data concerning the ambient environment, and to adjust the effect component by means of said sensor data;
instructions for receiving sensor data from one or more of the following: magnetometer, accelerometer, positioning means, camera or thermometer.

30. (canceled)

31. The computer program product according to claim 27, wherein for creating the theme the computer program product comprises instructions for performing one or more of the following steps:
collecting a hue histogram of hue of the source image,
collecting a pixel histogram of pixel values.
selecting the most common hue as dominant colour from the hue histogram,
finding median value from the pixel histogram,
blur the source image,
darken the source image depending on the median value,
use the source image as a background image for the theme,
use the dominant colour as theme colour,
select one or more font colours from the hue histogram,
modifying alpha value and/or colour of the effect component.

32.-33. (canceled)

34. The computer program product according to claim 27, wherein the effect component is configured to create an effect for at least part of the content component.

35. The computer program product according to claim 27, wherein the effect component is configured to change illumination levels on the user interface view by means of bump mapping.

36.-39. (canceled)

40. A method for creating a user interface view for an apparatus having a display, wherein the user interface view comprises user interface components, wherein the method comprises
automatically creating a them by means of a source image,
adjusting the created theme automatically based on sensor data, and
rendering the user interface view on the display according to the theme, wherein the theme defines a common appearance of the user interface components.

41. A method for creating a user interface view for an apparatus, wherein the user interface view comprises user interface components for defining the appearance of the user interface view, wherein the method comprises
receiving sensor data concerning the ambient environment,
adjusting at least part of the user interface components by means of said sensor data.

42. The method according to claim 41, wherein the method comprises adjusting effect of the user interface components by means of the sensor data, wherein optionally the sensor data relates to an ambient illumination level.

43. The method according to claim 42, wherein the effect defines illumination for the user interface view.

44. (canceled)
